(19) United States
(12) Patent Application Publication
(10) Pub. No.: US 2010/0257055 A1
(43) Pub. Date: Oct. 7, 2010

(54) Systems And Methods For Advertisement Lead Calling

(76) Inventor: Edward W. Mandel, Frisco, TX (US)

Correspondence Address: FISH & ASSOCIATES, PC;ROBERT D. FISH, 2603 Main Street, Suite 1000, Irvine, CA, 92614-6232, US

(21) Appl. No.: 12/824,846

(22) Filed: Jun. 28, 2010

Related U.S. Application Data
(63) Continuation-in-part of application No. 12/348,679, filed on Jan. 5, 2009.
Application No. 12/348,679 is a continuation-in-part of application No. 12/348,653, filed on Jan. 5, 2009.
Application No. 12/348,653 is a continuation-in-part of application No. 12/340,195, filed on Dec. 19, 2008.

(51) Int. Cl. G06Q 30/00

(52) U.S. Cl. 705/14.49

(57) ABSTRACT

Methods of allowing an advertiser to contact a remote user are disclosed. As a user interacts with a search engine, the search engine obtains advertisement data related to the user's search requests. The advertisement data can include an advertiser's contact information associated with one or more contact mechanisms, which can be correlated to the mechanisms available to the remote user. Once a common set of mechanisms has been identified; call request links are instantiated for each of the commonly available mechanisms. The remote user can select one of the call request links near an advertisement and submit their contact information for the corresponding contact mechanism. The search engine can send a call request, including the user's contact information, to the advertiser to enable the advertiser to call the remote user back.

This application claims priority to and is a continuation-in-part of U.S. patent application having Ser. No. 12/348,679 filed Jan. 5, 2009, which is a continuation-in-part of U.S. patent application having Ser. No. 12/348,653 filed on Jan. 5, 2009, which is also a continuation-in-part of U.S. patent application having Ser. No. 12/340,195 filed on Dec. 19, 2008. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is advertising technologies.

### BACKGROUND

The more quickly you can get a potential customer in contact with an advertiser, the greater the likelihood that the potential customer becomes a customer. Prior solutions only provide a link to the website or perhaps a phone number or e-mail address in the ad. Worse yet, most prior solutions require the potential customer to go to the advertiser's website to search for contact information.

The following references describe previous efforts applied to improving connections between consumers and advertisers.

U.S. patent application publication 2007/0100956 to Kumar titled “A System and Method for Enabling Prospects to Contact Sponsoring Advertisers on the Telephone Directly from an Internet-Based Advertisement with Just a Single-Click, and Efficiently Tracking from what Internet Location (URL) the Telephone Contacts are Initiated”, filed Oct. 29, 2005, discusses how a user can click on a call activator link to call an advertiser.

U.S. patent application publication 2007/0162334 to Altberg et al. titled “Systems and Methods to Convert a Call Generated from an Advertisement”, filed Aug. 24, 2006,describes presenting an advertisement of an adviser to a user. The user enters a callback number into the advertisement, which when clicked sends the callback number to the adviser. The adviser can call the callback number to connect with the user.

U.S. patent application publication 2007/0239524 to Tewahade titled “Enhanced Interactive Advertising”, filed on Apr. 3, 2006, discusses a system that allows a user to enter a callback from an advertisement landing page.

U.S. patent application publication 2007/0242626 to Altberg et al. titled “Methods and Apparatus to Connect People for Real Time Communications via Voice Over Internet Protocol (VoIP)”, filed May 22, 2008, describes a system by which users can search for listings relating to a search query. The user can select an advertisement to establish a connection with an advertiser.

The Yahoo!® blog entry by Jeff Sweat titled “Your Ads, Richer” (see URL www.ysmblog.com/blog/2009/02/18/your-ads-richer/), published Feb. 18, 2009, indicates a user can enter a zip code to obtain quest from an insurance company.

Interestingly, none of the known art appreciates that contact mechanisms available to the advertiser can be substantially different from those available to the consumer. Furthermore, the contact mechanisms available to a consumer can change dynamically as the consumer moves from one browsing platform to another.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

Thus, there is still a need for systems and methods for an advertiser to contact an interested consumer.

### SUMMARY OF THE INVENTION

The inventive subject matter provides apparatus, systems and methods in which a consumer can provide contact information to an advertiser. In some embodiments, a consumer or other remote user searches for information via a search engine. In response to a query the search engine can present search results. In addition, the search engine can obtain advertisement data relating to the search query or results, where the advertisement data includes contact information for the advertiser associated with one or more contact mechanisms, and includes the advertisement. The advertisement data can be parsed to determine which of the advertiser's contact mechanisms are available to the customer. Once the available contact mechanisms are obtained, a call request link can be generated and presented to the consumer. The consumer can enter their contact information associated with one of the contact mechanisms, and can send a call request to the advertiser. Upon reception of the call request, and the consumers contact information, the advertiser can contact the consumer.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 exemplifies a diagram of an advertisement lead calling system in a networked environment, in accordance with principles of the present disclosed subject.

FIG. 2 exemplifies a diagram of a method for providing advertisement lead calling, in accordance with principles of the present invention.

FIG. 3 contains a screen shot of advertisements having an advertisement lead calling icon (e.g., call request link), in accordance with principles disclosed herein.

FIG. 4 presents a possible method for an advertiser to contact a consumer.

### DETAILED DESCRIPTION

In the following discussion, numerous specific details are set forth to provide a thorough understanding of the present disclosed subject matter. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning the Internet, digital content, and the like have been omitted inasmuch as such details are not considered necessary to obtain a complete understanding of the present invention, and are considered to be within the skills of persons of ordinary skill in the relevant art.

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable media. For example, a server can include one or more computers operating as a web server, database server, or other type of computer server in a manner to fulfill described roles, responsibilities, or functions. One should appreciate that the disclosed techniques provide additional technical effect beyond mere computing devices. For example, the techniques described herein allow advertisers to efficiently communicate with consumers of communication networks.

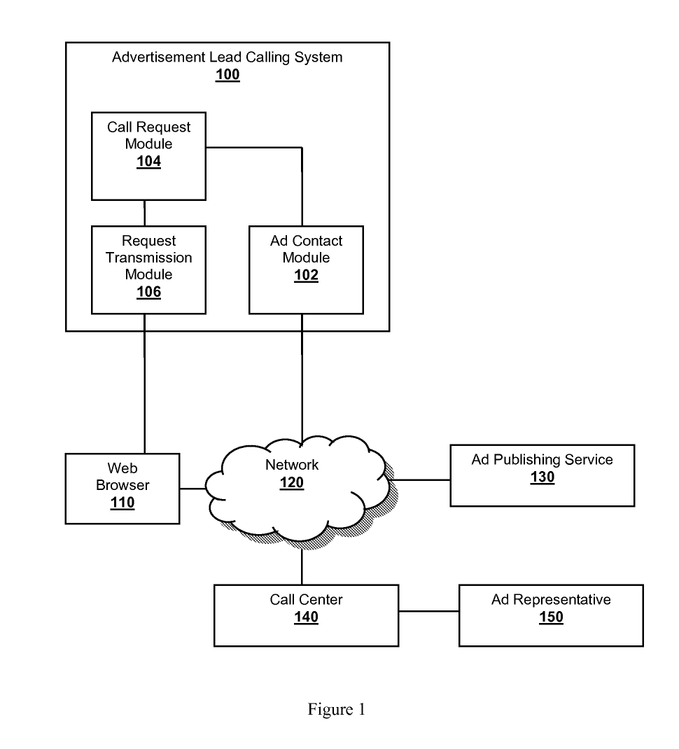

Referring to FIG. 1, there is shown a diagram of a live-interaction content rendering system (100) for providing live-interaction content associated with an advertisement over a network, in accordance with principles of the present invention. The system (100) is part of an application adapted to provide search results and advertisements associated with a search term. The application can be resident on a computer, a website, blog, forum, aggregator, and other suitable web-enabled application. The system (100) is preferably implemented in hardware, software, or a suitable combination of hardware and software thereof and may comprise one or more software systems operating on a digital signal processing platform or other suitable processing platforms.

As used herein, “hardware” can include a combination of discrete components, an integrated circuit, a microprocessor, a controller, a microcontroller, an application-specific integrated circuit (ASIC), an electronic data processor, a computer, a field programmable gate array, or other suitable hardware connectable for interfacing with a network, such as the Internet, considered to be well-known in the art. As used herein, “software” can include one or more objects, agents, threads, lines of code, subroutines, separate software applications, two or more lines of code or other suitable software structures operating in two or more software applications or on two or more processors, or other suitable hardware structures. Furthermore, it is considered that the design, development, and implementation details of all such hardware and software would be apparent to a person having ordinary skill in the art based upon a review of the present description of the invention. In one embodiment, software can include one or more lines of code or other suitable software structures operating in a general purpose software application, such as an operating system, and one or more lines of code or other suitable software structures operating in a specific purpose software application.

The system (100) is operably coupled to web-browser (110), advertisement publishing service (130), call center (140), and advertisement representative (150) by network (120). The network can be a WAN, MAN, LAN, PAN, and other suitable configuration. The system (100) is adapted to generate a communication request to provide live-interaction with a contact having information about an advertisement displayed in web-browser (110) and generates code adapted to instantiate a call request for the advertisement representative (150), of the call center (140), associated with advertisement contact information. The system (100) in this embodiment also includes advertisement contact module (102), call request module (104), and request transmission module (106).

The advertisement contact module (102) is adapted to receive advertisements from the advertisement publishing service (130) and parse out the information contained in the advertisement. In one embodiment, the advertisements are received as an XML transaction. In a second embodiment, the advertisements are received as a JSDN transaction. In a third embodiment, the advertisement information parsed is contact information for the advertiser. The contact information can include entries such as an e-mail address or generated e-mail address alias (for privacy), instant messaging address, text messaging number, VoIP Internet number, and other suitable contact information. The advertisement contact module (102) can be achieved with an application programming interface (API), a network connection, a network transfer protocol, HTML, DHTML, Java, JavaScript, Dojo, Ruby, Rails, other suitable formats and applications, or a suitable combination thereof

The call request module (104) is adapted to request the user's call request information and generate a call request for the user. The user selects an ad call icon disposed proximate the ad and a first pop-up window prompts the user to enter her call request information, such as name, phone number, requested call time, time zone, and other relevant call request information. After the user enters a valid phone number, the call request module (104) generates a call request having the call request information and the ad identification number. In one embodiment, an XML transaction is generated having the call request. In a second embodiment, a JSON transaction is generated having the call request. In a third embodiment, a plain-text message is generated having the call request. In a fourth embodiment, a text message is generated having the call request. In a seventh embodiment, the call center (140) can be an advertiser's phone number. The call request module (102) can be achieved with an application programming interface (API), a network connection, a network transfer protocol, HTML, DHTML, Java, JavaScript, Dojo, Ruby, Rails, other suitable formats and applications, or a suitable combination thereof.

The request transmission module (106) is adapted to transmit the call request to the appropriate destination. The call request can be transmitted according to the transmission preference listed in the contact information associated with the ad. In one embodiment, the call request is transmitted to the call center (140) via a text message over any suitable network. In a second embodiment, the call request is transmitted to the call center (140) via e-mail. In a third embodiment, the call request is transmitted to the call center (140) via a network transfer protocol. In a fourth embodiment, the call request is transmitted to the call center (140) via a network transfer protocol based on a data request from another application. In a fifth embodiment, the data request can be the GET command or other suitable transfer request command. In a sixth embodiment, the call center (140) listed in the contact information associated with the ad is the destination of the call request. The request transmission module (102) can be achieved with an application programming interface (API), a network connection, a network transfer protocol. HTML, DHTML, Java, JavaScript, Dojo, Ruby, Rails, other suitable formats and applications, or a suitable combination thereof.

In operation, the user sees an ad that he or she is interested in and desires to communicate with the ad representative (150) about the ad. However, the user does not have the ability to use one of the plurality of other communication mechanisms available (i.e., chat, videoconference, or other suitable internet communication). The present embodiment allows him or her to request, instead, that the advertisement representative (150) phone him or her to discuss the advertised product or service. To accomplish this, the user selects the ad call icon disposed proximate the ad of interest, enters an appropriate phone number, receives confirmation of the call request, and awaits the phone call from the ad representative (150). The system (100) then determines the call center (140) to which the request is to be sent based on the ad's contact information. The ad representative (150) calls the user at the phone number listed and discusses the product or service advertised.

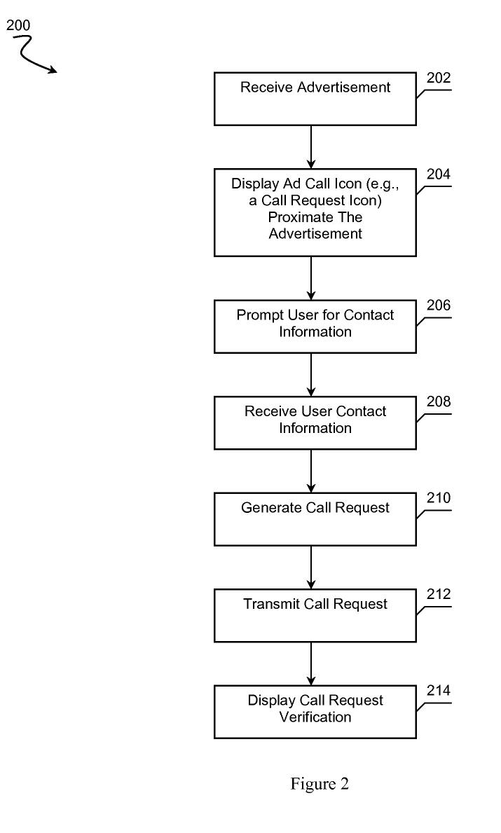

Referring now to FIG. 2, there is shown as a flow chart (200) exemplifying control logic embodying features of a method for providing advertisement lead calling in accordance with principles of the present invention. The advertisement lead calling control logic (200) can be implemented as an algorithm on a general purpose computing platform or other suitable microprocessor-based system.

The advertisement lead calling control logic (200) can leverage the ability of a computer platform to spawn multiple processes and threads by processing data simultaneously. The speed and efficiency of the advertisement lead calling control logic (200) is greatly improved by instantiating more than one process to implement a phone conversation between the user and the ad representative (150). However, one skilled in the art of programming will appreciate that use of a single processing thread may also be utilized and is within the scope of the present inventive subject matter.

The advertisement lead calling control logic (200) process flow of the present embodiment begins at step 202, where an advertisement is received from the advertisement publishing service (130) and the contact information contained in the advertisement is parsed. In one embodiment, the advertisements are received as an XML transaction. In a second embodiment, the advertisements are received as a JSDN transaction. In a third embodiment, the advertisement information parsed is contact information for the advertiser. The contact information can include entries such as an e-mail address or generated e-mail address alias (for privacy), instant messaging address, text messaging number, VoIP Internet number, and other suitable contact information. In a fourth embodiment, the advertisement contains contact information associated with the advertiser. The contact information can include entries such as an e-mail address or generated e-mail address alias (for privacy), instant messaging address, text messaging number, VoIP Internet number, and other suitable contact information. In a fifth embodiment, the advertiser may elect to provide the contact information of a call center, which can provide information relevant to the advertisement. The logic then proceeds to step 204.

At step 204, code is generated to display the ad call icon in the application proximate the advertisement. In one embodiment, the icons associated with the advertisement are disposed below the advertisement. The logic then proceeds to step 206.

At step 206, the user is prompted to enter her call request information. The user selects an ad call icon disposed proximate the ad and a first pop-up window prompts the user to enter her call request information, such as name, phone number, requested call time, time zone, and other relevant call request information. The logic then proceeds to step 208.

At step 208, the method receives and parses the user contact information. The logic then proceeds to step 210.

At step 210, the call request is generated. After the user enters a valid phone number, the call request module (104) generates a call request having the call request information and the ad identification number. In one embodiment, an XML transaction is generated having the call request. In a second embodiment, a JSON transaction is generated having the call request. In a third embodiment, a plain-text message is generated having the call request. In a fourth embodiment, a text message is generated having the call request. In a seventh embodiment, the call center (140) can be an advertiser's phone number. In one embodiment, a first pop-up window pops up in the web-browser (110). The logic then proceeds to step 212.

At step 212, the call request is transmitted to the call center (140). The call request can be transmitted according to the transmission preference listed in the contact information associated with the ad. In one embodiment, the call request is transmitted to the call center (140) via a text message. In a second embodiment, the call request is transmitted to the call center (140) via e-mail. In a third embodiment, the call request is transmitted to the call center (140) via a network transfer protocol. In a fourth embodiment, the call request is transmitted to the call center (140) via a network transfer protocol based on a data request from another application. In a fifth embodiment, the data request can be the GET command or other suitable transfer request command. In a sixth embodiment, the call center (140) listed in the contact information associated with the ad is the destination of the call request. The logic then proceeds to step 214.

At step 214, the user is notified that the call request was transmitted to the call center (140). In one embodiment, a second pop-up window is displayed in web-browser (110) summarizing the call request details and notifying the user that the call request was successfully transmitted or pending transmission.

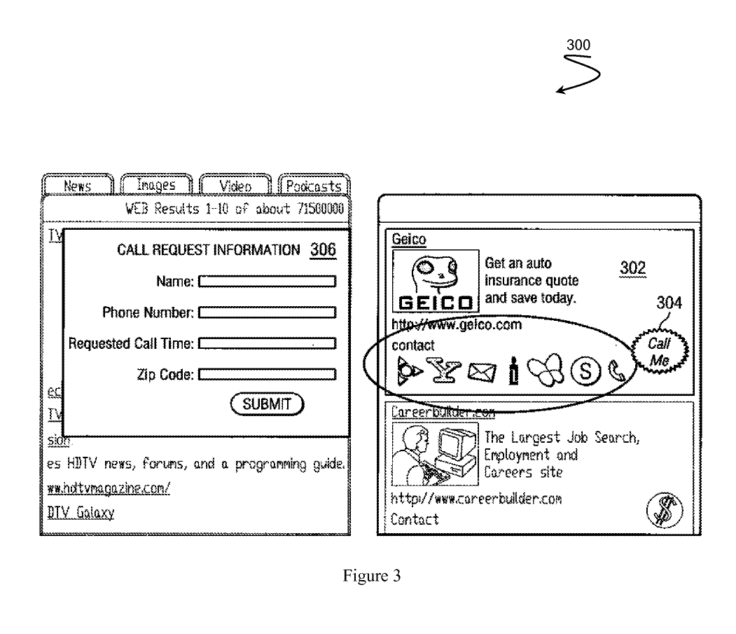

Referring now to FIG. 3, there is shown at (300) a screen shot of a web-browser (110) rendering an advertisement (302), an ad call icon (304), associated with the advertisement, and a first pop-up window (306), in accordance with principles of the present invention. In one embodiment, the ad call icon (304) can generate a call request requesting that the ad representative (150) calls the user regarding the ad when the user selects the ad call icon (304). In a second embodiment, the user provides information related to her call request in the first pop-up window (306) and submits the call request information, thereby requesting that the ad representative (150) call her.

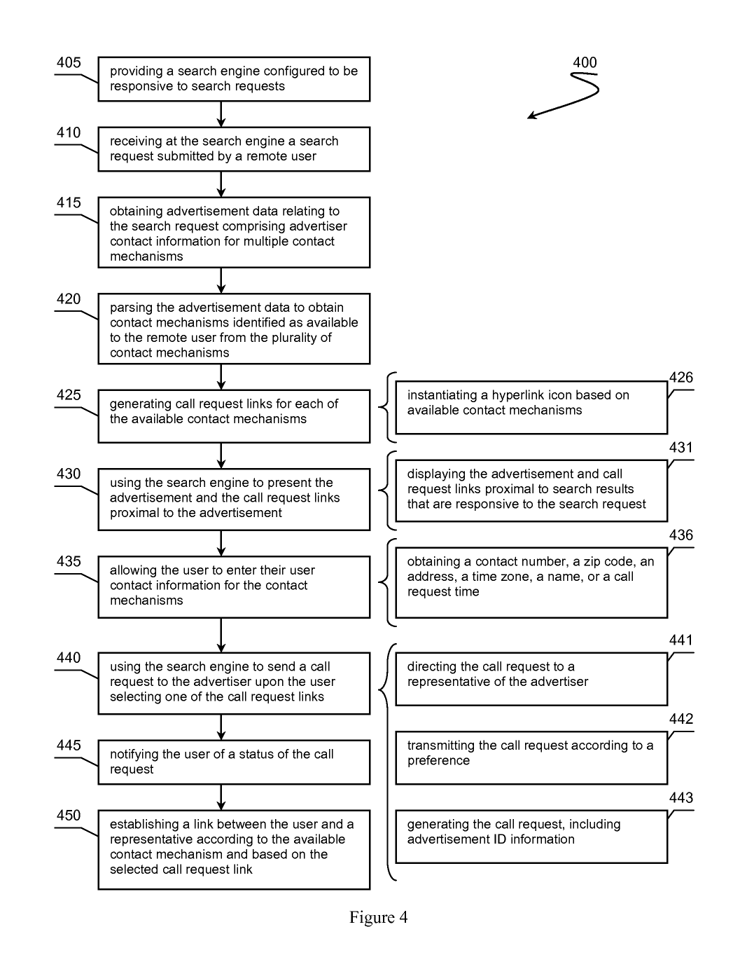

FIG. 4 provides one possible method (400) of allowing an advertiser to contact a consumer or other remote user.

At step 405, access to a search engine can be provided to a remote user. Example search engines can include publicly available Internet search engines (e.g., Yahoo!, Google, MSN, AltaVista, etc.), commercial search engines (e.g., EBay, Amazon, etc.), or other computer systems configured to respond to search requests or query. In some embodiments, access can be provided using traditional browser applications capable of accessing remote databases over the Internet as discussed above. It is also contemplated that access can be provided through public or private APIs, possibly including web services. For example, a remote database having a secured web-services API could be considered an accessible search engine.

At step 410 the search engine receives a request submitted by a remote user. The request can comprise different types of data sent to the search engine. Traditionally a remote user would enter keyword or search terms into a field of a browser application and submit the keywords to the search engine. It is also contemplated that the search request could extend beyond text and could include audio data, video data, image data, sensor data (e.g., accelerometer, GPS, compass, microphone, etc.), or other forms of data that could be used to find search results. For example, the user's browsing platform can include a cell phone, where the user's search request can include data collected by the cell phone's sensors. One should appreciate as the user shifts from one browsing platform to another, or from one location to another, the number of contact mechanisms available to the user could change to reflect their current circumstances.

At step 415 advertisement data can be obtained. In more preferred embodiments, the search engine can communicate with one or more advertisement servers possibly operated by one or more ad publishing services. The advertisement data preferably relates to the search request.

One should appreciate there a numerous methods by which advertisement data can be identified as relating to the search request. In some embodiments, keywords are matched to metadata associated with the advertisement data. In more complex embodiments, advertisements can be tagged or correlated with a remote user's location, with ambient data collected by sensors near the remote user, with audio or visual information, or other correlations. For example, a user's cell phone can provide sensor data that can be used to find relevant search results or advertisements.

Advertisement data preferably includes an advertisement tailored for presentation to the remote user and advertiser contact information. The various parts of the advertisement data (e.g., images, audio, text, metadata, advertiser contact information, call request transmission preferences, etc.) can be encoded in XML or other acceptable formats as discussed previously. The advertiser's contact information preferably includes instructions for instantiating a communication link with the advertisers according a plurality of contact mechanisms. Each contact mechanism is considered to be distinct when based on different underlying protocols. For example, VoIP is considered to be distinct from traditional POTS because each system utilizes a different infrastructure to establish a communication link. Likewise text message (e.g., SMS) is considered a distinct from instant messaging.

The instructions for establishing a communication link associated with the contact mechanism are, naturally, different from one mechanism to another. In some scenarios, the instructions could be a web base link, a URL address, or other type of web instructions. The instructions can also include a call to an application resident on the browsing hardware (e.g., PC, PDA, cell phone, game console, etc.) possibly to launch an email application or a VoIP application. All types of instructions are contemplated.

Interestingly, previous approaches for establishing a communication session between an advertiser and a remote user have failed to appreciate there can be a mismatch between the communication mechanisms available to an advertiser and the mechanisms available to the remote user. One should appreciate that a remote user might not have access to all possible communication mechanisms available to an advertiser. Likely, an advertiser or their designated representatives would have access to many different contact mechanisms. A typical remote user would likely have access to only a few contact mechanisms, especially in view that a remote user can be mobile or can change browsing platforms.

At step 420, the advertisement data relating to the user's search request is parsed to obtain available contact mechanisms identified as being available to the remote user. The search engine can review the advertiser's contact mechanisms listed in the advertisement data and correlate them with those available to the remote user. In some embodiment, the search engine can store a list of remote user contact mechanism preferences, while other embodiments might query the remote user's browser platform for available contact mechanisms that are currently available or would likely become available. Regardless of the method used to correlate the contact mechanisms available to both the advertiser and the remote user, the search engine preferably builds a list of commonly available contact mechanisms. The term “commonly” is used to reference that the available contact mechanisms are jointly available to both entities (e.g., the intersection of sets). One should appreciate that the list of available contact mechanism obtained by parsing the advertisement data might have fewer entries than the total number of contact mechanisms available to the remote users, as the intersection of the two sets of lists might be small.

At step 425, call requests links can be generated for each of the identified available contact mechanisms that are available to the user and to the advertiser. The call request links can take many different forms. In some embodiments, the call request link can instantiate an immediate communication session upon the user selecting the call request link. While in other embodiments the user can be prompted for call back information upon selection of the call request link. Step 426 can include instantiating a hyperlink icon representative of an available contact mechanism (see FIG. 3, element 302) that includes instructions to engage the user to establish a communication link. One should note that instantiation of a hyperlink icon can be preformed by the search engine as it is building a search result page rather than having a priori defined icons. Such an approach allows for customization of the icon, and underlying instructions, to best fit the target remote user. For example, the icons could be instantiated according to the user's preferences, or the instructions could be tailored toward a preferred communication carrier (e.g., Verizon, AT&T, T-Mobile, Skype, etc.), possibly by depicting a logo.

Instantiating a call request link can be more extensive than merely providing code to a browser to render an icon. Instantiating a call request link can include forming a data entry link where the user is prompted for information (e.g., contact information). The data entry link could include one or more data entry fields or form. In other embodiments (see FIG. 3), the link can include a button or icon that launches additional windows or even a new application to acquire the user contact information. Instantiation of a call request link can also include preparing code or instructions on the search engine side capable of coordinating user interactions with the call request link. For example, the search engine could prepare a temporary URL that remains active for a specified period of time while the advertisement is considered active. Furthermore, it should be appreciated that the call request link can be instantiated in real-time upon reception of the advertisement data rather than using a priori formatted links. Preferred hyperlink icons represent a live-contact mechanism (e.g., VoIP, instant messaging, video conferencing, etc.).

At step 430 the remote user is presented with the advertisement obtained from the advertisement data and with the call request links proximal to the advertisement. It should be noted that the call request links preferably correspond to those contact mechanisms that are commonly available to both the advertiser and remote user. Such an approach ensures the remote user can be retained as a lead by reducing a risk that the user could select an inoperative link. In yet more preferred embodiments, the advertisement and links are also presented proximal to search results obtained by the search engine in response to the remote user's search request as indicated by step 431.

At step 435, upon the remote user selecting on the call request links, the user can enter their user contact information corresponding to the selected contact mechanism. The user's contact information can include a wide variety of data that can be used to aid an advertiser representative in responding to the user's indicated interest in the advertisement. For example, at step 436, the contact information is contemplated to include a zip code, a phone number, a time zone, a name, or a call request time. The information could further include email address, URL, location, audio or visual data, VoIP address, interests, or other information. The user contact information is preferably used to aid the advertiser or their designated representative to contact the user. It is also contemplated that the user contact information can include user supplied data representing the user's core interest for selecting the ad. For example, the user could reference a desire for a quote, status of in-stock items, or any other requests.

At step 440, the call request is sent to the advertiser, or possibly to a designated representative (see step 441), after the user selects a call request link. The call request can be packaged in any suitable protocol for delivery over the Internet to the advertiser. Preferred call requests include the user's contact information.

At step 442, in embodiments where the advertisement data includes a preferred call request transmission format, the call request can be sent to the advertiser according their specified preference. One should note that a selected call request icon might specify a first communication mechanism; however, that mechanism might not be suitable for transferring the call request. For example, a remote user might select a traditional POTS call request link to indicate they would like to receive a call back at their home phone, while the call request having their home phone number would likely be sent electronically via email, instant message, database command, or other form. The advertiser's call request preference could be different for each contact mechanism or for each call request link.

In yet more preferred embodiments, the call request also includes identification information to identify the advertisement as suggested in step 443. Advertisement identification can identify the advertisement at many different levels. For example, the advertisement identifier could be an encoded value that identifies, even uniquely identifies, an ad campaign, an ad publisher, the search engine, the user, a specific instance of the advertisement, an impression (e.g., a specific showing of the advertisement to the remote user), or other level. Such an approach allows the advertiser to properly track how effective their advertisements are. Furthermore, the disclosed approach provides for uniquely identifying an advertisement on an impression-by-impression basis.

At step 445, a notification can be sent to the remote user to indicate a status of a call request. In some embodiments, the notification could include a basic message indicating reception of the call request. More complex embodiments can provide a periodic or even continuous status of the call request. Call request status could comprise different states reflective of how a call request is being processed including received, pending, processed, call made, lost, forwarded, or other states.

The notification can also be sent via one or more different contact mechanisms. In some embodiments, the notification is sent according to the user selected contact mechanisms. It is also contemplated that the notification could be sent through other mechanisms as well including those that are not represented by the instantiated call request icons.

At step 450, a communication link is established between at least an advertiser's designated representative and the remote user. As discussed previously the communication link can be constructed immediately in response to the user selecting a call request link, or based on the contact information submitted by the user where the representative calls the user back. The communication link can also be established via the search engine, or other third party, as a proxy to retain privacy of the user.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of allowing an advertiser to contact a consumer, the method comprising:
providing access to a search engine configured to be responsive to search requests;
receiving at the search engine a search request submitted by a remote user;
obtaining advertisement data by the search engine relating to the search request, where the advertisement data comprises advertiser contact information associated with a plurality of contact mechanisms, and comprises an advertisement;
parsing the advertisement data to obtain available contact mechanisms from the plurality of contact mechanisms, the available contact mechanisms identified as available to the remote user;
generating automatically, after parsing the advertisement data, call request links for each of the available contact mechanisms;
using the search engine to present the advertisement and the call request links proximal to the advertisement;
allowing the user to enter their user contact information corresponding to at least one of the available contact mechanisms in response to presentation of the advertisement; and
using the search engine to send a call request to the advertiser upon the user selecting one of the call request links, the call request comprising the user contact information.

2. The method of claim 1, wherein the step of generating the call request links includes instantiating a hyperlink icon according to one of the available contact mechanisms.

3. The method of claim 2, wherein the one of the available contact mechanisms comprises a live-contact mechanism.

4. The method of claim 1, wherein the step of allowing the user to enter contact information includes obtaining from the user at least one of the following user contact information from the user: a contact number, a zip code, an address, a time zone, a name, and a call request time.

5. The method of claim 1, wherein the step of using the search engine to send the call request comprises generating the call request, where the call request includes advertisement identification information.

6. The method of claim 1, further comprising transmitting the call request to the advertiser according to a preference listed in the advertisement data.

7. The method of claim 1, further comprising directing the call request to a designated representative of the advertiser.

8. The method of claim 1, further comprising notifying the user of a status of the call request.

9. The method of claim 1, further comprising the search engine displaying the advertisement and call request links proximal to search results that are responsive to the search request.

10. The method of claim 1, further comprising establishing a communication link between the user and an advertiser representative according to the at least one available contact mechanism based on the user contact information in the call request and on the selected call request link.
